(19) United States
(12) Patent Application Publication
(10) Pub. No.: US 2022/0191394 A1
(43) Pub. Date: Jun. 16, 2022

(54) METHOD AND SYSTEM FOR REMOTE VIDEO MONITORING AND REMOTE VIDEO BROADCAST

(71) Applicant: KYOCERA Corporation, Kyoto (JP)

(72) Inventors: Paul M. RUSSO, Los Altos Hills, CA (US); Jonathan RUSSO, La Jolla, CA (US); Michael RUSSO, La Jolla, CA (US)

(73) Assignee: KYOCERA Corporation, Kyoto (JP)

(21) Appl. No.: 17/652,915

(22) Filed: Feb. 28, 2022

Related U.S. Application Data
(63) Continuation of application No. 15/700,072, filed on Sep. 8, 2017.
Application No. 15/700,072 is a reissue of application No. 13/519,065, filed on Jun. 25, 2012, now Pat. No. 9,131,257.

(51) Int. Cl. H04N 5/232; H04N 13/194; H04N 13/122

(52) U.S. Cl. CPC H04N 5/23238; H04N 5/23299; H04N 13/122; H04N 13/194; H04N 5/23206

(57) ABSTRACT

A distribution system for an image distribution via a network and a method of distributing image data via a network are disclosed. The distribution system includes a video capture device having a plurality of cameras for capturing image date to generate 360-degree image and a server. The video capture device transmits the captured image data to a server via a network. The server receives the image data transmitted from the video capture device and delivers the image data to a viewing device depending on a request from the viewing device to display the video image on the viewing device.

### CROSS REFERENCE TO RELATED APPLICATIONS

This application is a continuation of U.S. application Ser. No. 15/700,072, filed Sep. 8, 2017, which is a Reissue Application of U.S. Pat. No. 9,131,257, issued Sep. 8, 2015, from U.S. application Ser. No. 13/519,065, which claims priority to International Application No. PCT/US2011/59357, filed Nov. 4, 2011, the contents of which are incorporated herein by reference.

### FIELD

The embodiments described herein relate generally to video processing and communications, and relate particularly to remote viewing of video monitoring devices over a network. As an additional aspect, the remote viewing can provide a vantage point which differs from viewer to viewer.

### BACKGROUND

Video monitoring and surveillance devices such as security cameras have been used for security monitoring, traffic control, baby/elderly monitoring, video-conferencing etc. In recent years, with advances in internet and video communications as well as user accessories such as webcams, digital cameras, camcorders, and generally Personal Digital Assistant (PDA) devices, it has been possible to view or broadcast a large volume of video and audio information over the internet. In particular, there has been a migration from closed circuit systems to network control systems for video surveillance applications. There exist commercial services therewith users can install a number of cameras in their properties (e.g. home, office, backyard, or vehicle) and subscribe to a service that provides either a central monitoring service by the service provider or enables users for self-monitoring over the internet.

A majority of existing solutions are localized, meaning the monitoring cameras are installed in a place, or mounted on a vehicle. Examples are home security monitoring services, video conferencing and web broadcasting of events. While there are a number of wireless IP cameras in the market, some of which reasonably small and easily portable, the application of such devices has been limited to local (small range) networking.

There are also popular ways of broadcasting videos to a small audience, or establishing a video conference link between a few participants. Examples are Skype, Oovoo, and web chat applications where a very limited number of participants can visually connect via a Graphical User Interface (GUI) application software on their personal computers. These applications have limited flexibility of use in addition to lack of continuous monitoring capabilities.

There is a need for a service and its backbone infrastructure that can provide video monitoring capabilities from a mobile type of device to preferably mobile users. The present invention provides with embodiments that describe methods and systems for viewing live or recording images streamed from small portable video monitoring devices. For example images from a pocket-sized wireless IP video camera can be delivered to a viewers' PDA. In other words, users can place their portable cameras anywhere and watch, or let other viewers watch, the live images transmitted by the cameras from any place as long as a communication link and networking is available. In particular it is advantageous to equip the camera with a wide-angle lens, such that widening the viewing angle and eliminating mechanical controls would minimize the size and number of the monitoring cameras and facilitates their mobility and ease of use. Further, the present invention provides with a method to deliver a service as a business venture.

### SUMMARY

The embodiments described herein provide in one aspect a distribution system for an image distribution via a network. The distribution system comprises: a video capture device having a plurality of cameras for capturing image data to generate 360-degree video image and configured to transmit the captured image data to a server via a network; and the server configured to receive the image data transmitted from the video capture device, and to deliver the image data to a viewing device depending on a request from the viewing device to display the video image on the viewing device.

The embodiments described herein provide in another aspect a method of distributing image data via a network. The method comprises: capturing image data to generate 360-degree video image by a plurality of cameras of a video capture device; transmitting the captured image data from the video capture device to a server via a network; receiving, at the server, the image data transmitted from the video capture device; and delivering the image data from the server to a viewing device depending on a request from the viewing device to display the video image on the viewing device.

### BRIEF DESCRIPTION OF THE DRAWINGS

For a better understanding of the embodiments and/or related implementations described herein and to show more clearly how they may be carried into effect, reference will now be made, by way of example only, to the accompanying drawings which show at least one exemplary embodiment and/or related implementation in which:

FIG. 1 illustrates general service contract between a provider and plurality of subscribers;

FIG. 2 illustrates the relationship between various elements of the embodied video monitoring system;

FIG. 3 illustrates an exemplary interface on a viewing device, wherein a viewer can watch video images from a plurality of monitoring devices, and interact with them;

FIG. 4 illustrates an exemplary broadcasting configuration from the service user;

FIG. 5 illustrates an exemplary application wherein different viewers can view a selected portion of a panoramic view using PTZ capabilities; and

FIG. 6 illustrates an exemplary embodiment where capturing devices broadcast to different viewing devices and each viewing device shows a different customizable vantage point.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

It will be appreciated that numerous specific details are set forth in order to provide a thorough understanding of the exemplary embodiments described herein.

However, it will be understood by those of ordinary skill in the art that the embodiments and/or implementations described herein may be practiced without these specific details. In other instances, well-known methods, procedures and components have not been described in detail so as not to obscure the embodiments and/or implementations described herein. Furthermore, this description is not to be considered as limiting the scope of the embodiments described herein, but rather to describe the structure and operation of the various embodiments and/or implementations described herein.

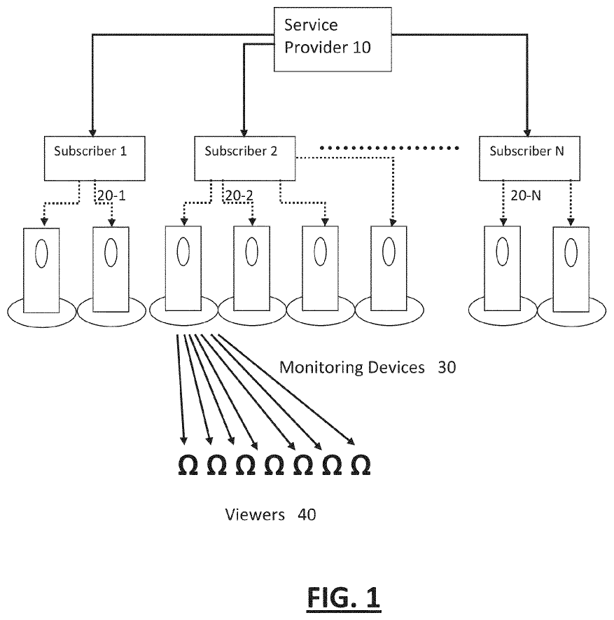

FIG. 1 illustrates one embodiment of the invention. A service provider 10 signs up or registers a plurality of subscribers 20-1 to 20-N to a video (and audio) monitoring and broadcasting service. Each subscriber has at their premises at least one portable monitoring device 30, e.g. a handheld video camera, for personal or business use, wherein video images streamed from the cameras can be viewed by the subscriber or be shared with a plurality of viewers 40. Subscribers may separately buy or lease the devices, or obtain them free of charge upon signing a term contract. The service provider 10 then sets up each subscriber 20 with an online account where a viewer 40 can login securely to a website via the internet and view live images streamed from the monitoring devices over a network. It should be noted that viewers are not necessarily the subscribers. For example, a corporation may subscribe to the service and obtain a number of monitoring devices 30 for its employees. As another example, that will be described later, a subscriber grants a number of third party viewers the login and access privileges to view images from a common scene. For clarity in terminology, a viewer (also interchangeably referred to as user) applies to a subscriber and other third party viewers, as far as the technology is concerned. There is a difference between a subscriber and a non-subscribing viewer in terms of business relationships.

It should further be noted that video data may be accompanied by audio that can be utilized in many applications. Although the main focus on this invention is on video information, the disclosed techniques can be applied to audio data or audio/video combination of data.

The service provider 10 operates a cloud server or other network where the subscribers 20, all viewers 40, and the monitoring devices 30 connect to. The cloud is hosted in a shared pool of computing resources in locations unknown and irrelevant to the users. The server could also be a network of clouds interconnected through the internet. In addition to acting as a central hub for communications, the cloud server provides (directly or through a third party) bandwidth management, data compression, data encryption, data storage, real-time or offline image processing, maintenance of user accounts, contacting a third party, and related services.

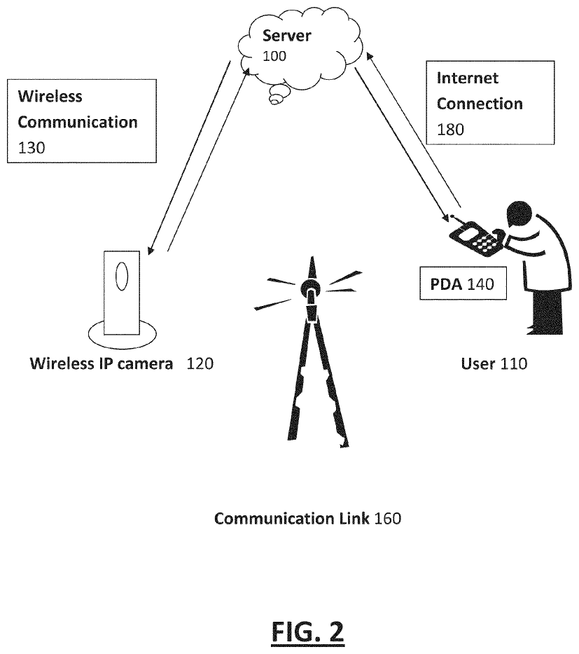

FIG. 2 illustrates an exemplary embodiment. The service provider operates a server in the cloud 100 for delivering the service to the users. A user 110 may access the online account via a viewing device 140. Preferably, the viewing device 140 acts also as hardware interface for the user. It could be a mobile device such as a personal laptop, a cellular device, tablet, etc., generally referred to as a PDA. The user 110 accesses the service by logging into his set-up account either through an internet browser or a through custom application GUI (GUI App) downloadable onto the PDA. The application may also be available via a social networking site. The service requires an internet connection 180 with the cloud servers 100 provided by any means. In a preferred embodiment the service uses a continuous communication 130 between the server 100 and the monitoring device 120 (e.g. a wireless IP camera in an exemplary embodiment) on the network provided by a communication link 160. In particular, the communication link between the camera 120 and at least portions of the communication network is preferably of wireless form, provided by various means, for instance one or any combination of cellular, Wi-Fi, Bluetooth, or satellite methods. A wireless communication enhances the portability of the monitoring devices to include secluded or untraditional places where no other communication infrastructure exists.

According to an embodied method, the server receives live images in real-time from a plurality of monitoring devices 120 connected to the network. In addition to rerouting the received images to the subscribers' accounts in real-time, the server may record and save several hours of the captured video up to a prescribed storage capacity, upon the user's request. Users would then have the option to play back the stored clips, apply extra post-processing of images, email the clips to others, move and save them locally, and delete after viewing or automatically after a certain period of time. Some or all the real-time and/or offline image processing tasks can also be performed by the server, if equipped with image processing units. Those include, but are not limited to, geometric transformations, optical corrections, color/brightness adjustments, image scaling, detail enhancement, noise reduction and monitoring device (camera) calibration. Having the image processing performed at the cloud server substantially lowers the cost of monitoring units. In principle, a monitoring device can act solely as a video (and optionally audio) capture and transmitter.

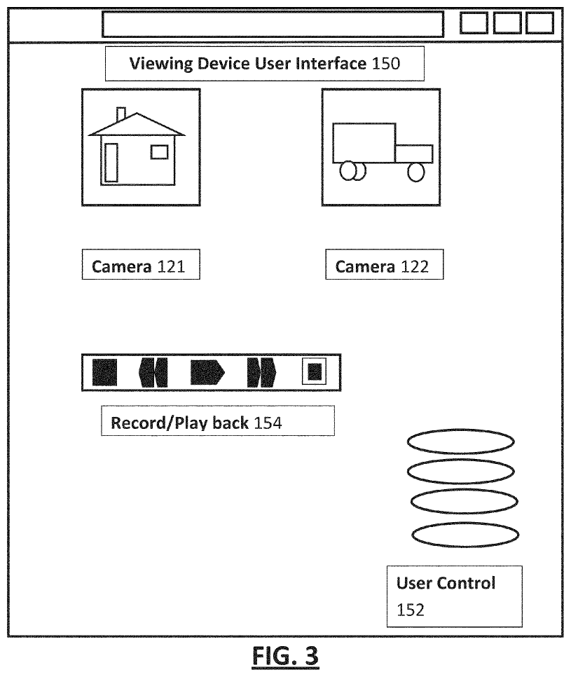

By accessing the online account through an interface 150 on a viewing device, as shown in FIG. 3, a viewer is able to access a plurality of video cameras and view the streamed video images in real-time. For example, he can select camera 121 monitoring the house and camera 122 monitoring the car in this exemplary illustration. In an alternative embodiment, a user may select recording option 154 and save the captured image data on the server in order to play them back offline at a later time. The user is capable of manipulating the saved image data by adjusting control settings 152, applying editorial commands, download selected clips on his PDA or email video clips to other parties.

It is preferred that the monitoring devices 120 to be mobile and easily get carried around and placed anywhere as stand alone units. In one embodiment, the monitoring device is a handheld video camera comprising image sensors, and optics. Analogous to other small personal devices such as cell phones and digital cameras, ease of use implies no permanent mounting or wiring. As such, the monitoring devices 120 should have wireless communication capabilities. They should operate on batteries (rechargeable, solar cell, disposable) in addition to having optional USB power or AC adaptors for extended use or battery charging. Further, each device should be uniquely recognizable on the internet by a unique IP address, preferably a dynamic IP address for higher security.

In one exemplary embodiment, an image processing unit may be integrated to the monitoring device so that some image processing operations including geometric transforms, optical corrections, color/brightness adjustments, scaling, detail enhancement, noise reduction and camera calibration can be performed locally at the monitoring device. Although this option would make the device more costly, it would save communication bandwidth and prevent the network from overuse. This option may be desirable for more sophisticated users.

In one embodiment, the monitoring device is equipped with a wide-angle lens (such as a fisheye lens) for capturing a large field of view. It is also possible to use a combination of wide-angle lenses to enable the device with panoramic or even up to a 360° of viewing capabilities. This would increase the viewing angle without a need for mechanically moving the camera, as is the case in some existing products. It further eliminates the need to use more than one camera to cover one area. Alternatively, a user can arrange a number of devices, e.g. two back to back cameras each having a 180° fisheye lens, to get an equivalent viewing experience. In this case the processing power of the cloud server is further increased to accommodate extra user control instructions, more notably operations such as pan/tilt/zoom (PTZ), horizontal/vertical flip and rotation. Additionally, the optional image processing unit integrated to the device may be enabled to perform the flip, rotation and PTZ operations locally at the camera. These types of processing are known to those skilled in the art, such as U.S. Pat. No. 7,324,706. Other examples include U.S. Pat. Nos. 7,474,799; 7,576,767 and U.S. Pat. No. 8,055,070.

In another exemplary embodiment, the monitoring device includes a motion sensor. To save energy and minimize the amount of unnecessary data collection or communication, e.g. in a video monitoring application, the motion sensor can trigger the video transmission and/or recording upon detecting motion within the range of view. Moreover, the monitoring device can be programmed to go dormant when no motion is detected after a certain period of time. The same concept is applicable to sound detection. Several other optional features can be added to the monitoring device's functionality depending on applications required by subscribers. Exemplary options are, but not limited to, augmenting a GPS, gyroscope or compass for acquiring positional and directional coordination information, integrating an infrared imagery means for night vision imaging, adding a speaker, a flash light, an LED indicator, etc.

In another exemplary embodiment, the monitoring devices could be equipped with memory and disk space to optionally record a few hours of video streaming for backup purposes, for instance in case of network connection disruptions. Additionally, the device may regularly test the connection to the cloud server (e.g. by pinging) and automatically start/stop recording upon disconnect/reconnect to the network.

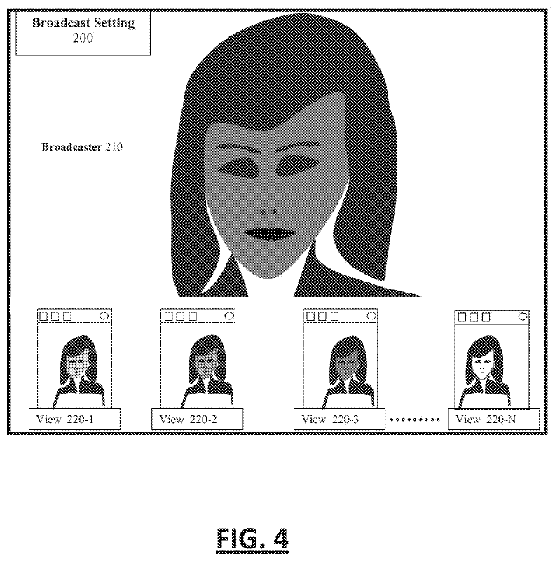

As mentioned above, the subscribers have an option to share the login privileges with a plurality of third party viewers. FIG. 4 illustrates an exemplary embodiment of a broadcast application setting 200, where the cloud server accommodates simultaneous logins to the server and multiple viewing of images transmitted by a user broadcaster 210 through her mobile monitoring device.

This is particularly useful when the user intends to broadcast an event to a plurality of viewers. Each viewer watches the broadcaster 210 simultaneously on their own viewing devices (views 220-1, 220-2, . . . , and 220-N) by logging into the assigned website on the server. Further, each viewer can independently control and perform image processing functions such as electronic pan, tilt and zooming (PTZ) to personalize their viewing experience of the common scene without affecting other viewers. If multiple cameras are networked together, each viewer can choose which camera(s) to view at any one time. Examples of the usefulness of group viewing are business travelers, music bands, sporting teams/individuals, speakers, entertainers, family events and alike. Subscribers can grant their family, friends and fans online viewing privileges virtually from anywhere, and provide them with a personally customized viewing experience.

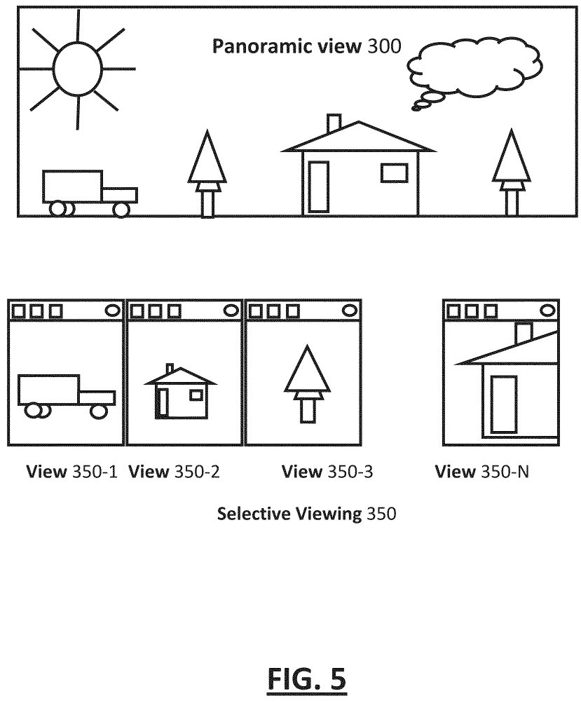

FIG. 5 illustrates an exemplary application where a monitoring device equipped with a wide-angle lens streams a panoramic view 300 of a scene. A plurality of viewers may simultaneously access the video but pick different views (350-1 to 350-N) of the same panorama on their own displays. The viewers have the ability to move around the image (pan and tilting) to pick a portion of the view, and further zoom in (e.g. 350-N) and out (e.g. 350-2) as long as permitted by digital zoom capability of the camera lens. A web interface or a custom app provide by the service provider facilitates user's interaction with the image.

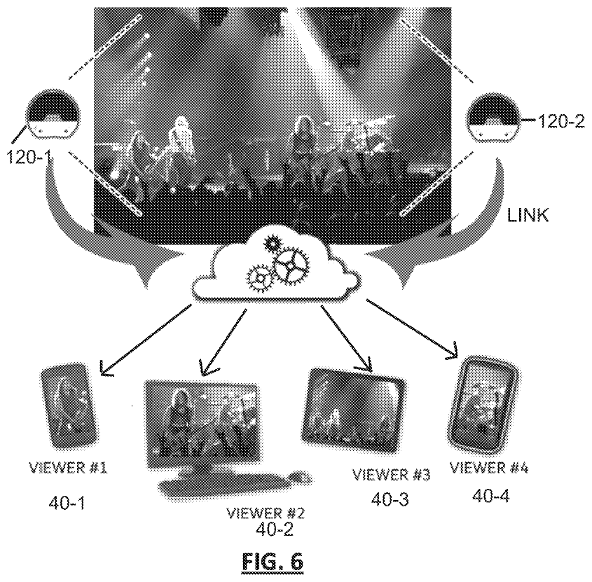

FIG. 6 illustrates an exemplary embodiment whereby multiple image capture devices (indicated by circular reference elements 120-1 and 120-2) are installed at an event, such as a concert. The image data is transmitted via a communication link and/or network to multiple end users, who have registered or are otherwise authorized to view the image data. Each of the multiple end user devices 40-1, 40-2, 40-3 and 40-4 is able to display a different view of the event. This is based on user-controllable signals that are transferred back to either an event site or a server site to adjust one or more of the video streams from capture devices installed at the event. Such vantage point adjustments controllable by the user can include a downloadable set of commands for flip, pan, tilt or zoom, for example.

As long as a communication link is available, users are able to view live or pre-recorded images through the server and over the internet. Further, users may remotely control and interact with their cameras in real-time. The image processing tools can be integrated with the monitoring device or be part of the server's computing capabilities. In the latter case, simultaneous user interaction with one device is possible without interfering with other users. The server can also store multiple copies of received image data from a location, and a viewer can select which of the views or copies are to be displayed and manipulated.

The disclosed technology opens up various useful applications for subscribers to the service. A traveler may carry a monitoring camera where his family from home or colleagues from work could see him anywhere he is. A user can place one small mobile camera at home, inside car, in a hotel room, etc. for monitoring the area. It would eliminate need for multiple cameras, local networking setups, and subscription to multiple services.

Referring back to FIG. 1, the service provider 10 may charge the subscribers using various means. Subscribers 30 may pay an initiation or sign-up fee followed by a periodic (monthly, annual, etc.) subscription fee. Further, for a large volume of data communication that requires extra bandwidth, the service provider can be compensated proportionally. That also applies to volume of recorded video data that is stored on the server. The service provider 10 may provide monitoring devices free of charge but charge for usage, or charge advertisers on its websites. Further the subscribers 30 are able to setup a sub-contract or pay-per-view arrangement to monetize their broadcast. For example, a live band may grant online access to their viewers 40 for a charge. Additionally, they may collect royalty from advertisers. A royalty based or bandwidth usage based compensation can also be arranged between the subscriber 30 and the service provider 10.

The functional aspects of registering subscribers, controlling access to images and the network, managing data and mediating access to the network can be implemented on one or more programmed processors. The specific details are within the abilities and knowledge of one skilled in the art, and the details are not set forth here.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

What is claimed is:

1. A distribution system for an image distribution via a network, comprising:
a video capture device having a plurality of cameras for capturing image data to generate 360-degree video image, and configured to transmit the captured image data to a server via a network; and
the server configured to receive the image data transmitted from the video capture device, and to deliver the image data to a viewing device depending on a request from the viewing device to display the video image on the viewing device.

2. The distribution system according to claim 1, further comprising
the viewing device configured to selectively display a view of the 360-degree video image from the image data.

3. The distribution system according to claim 2, further comprising
a plurality of viewing devices including the viewing device, and configured to receive the image data from the server and to simultaneously display the 360-degree video image, wherein
each of the viewing devices is configured to display a different view of the 360-degree video image.

4. The distribution system according to claim 3, wherein
each of the viewing devices is configured to individually control a display of a common scene depending on user's operation without affecting other viewing devices.

5. The distribution system according to claim 2, wherein
the viewing device is configured to perform a display control depending on user's pan/tilt/zoom operation without affecting other viewing devices.

6. The distribution system according to claim 1, wherein
the video capture device comprises two back to back cameras each having about 180-degree angle of view.

7. The distribution system according to claim 1, wherein
the server is configured to deliver the image data to the viewing device authorized by a subscriber of a service for delivering the image data.

8. The distribution system according to claim 1, further comprising:
a plurality of video capture devices including the video capture device; and
the viewing device configured to display a view of the 360-degree video image selected among a plural pieces of image data captured and transmitted from the plurality of video capture devices.

9. The distribution system according to claim 1, further comprising
the viewing device configured to display a view of the 360-degree video image by a custom graphical user interface (GUI) application.

10. The distribution system according to claim 9, wherein
the viewing device is configured to download the custom GUI application via a social networking site.

11. A method of distributing image data via a network, comprising:
capturing image data to generate 360-degree video image by a plurality of cameras of a video capture device;
transmitting the captured image data from the video capture device to a server via a network;
receiving, at the server, the image data transmitted from the video capture device; and
delivering the image data from the server to a viewing device depending on a request from the viewing device to display the video image on the viewing device.
